(19) United States
(12) Patent Application Publication
(10) Pub. No.: US 2003/0079575 A1
(43) Pub. Date: May 1, 2003

(54) Torque multiplier

(76) Inventors: Brenda Erica Blanco Guajardo, Monterray (MX); Salvador Kamar Gomez, Monterray (MX)

Correspondence Address: LAW OFFICE OF JAY R. YABLON, 910 NORTHUMBERLAND DRIVE, SCHENECTADY, NY, 12309-2814, US

(21) Appl. No.: 09/682,855

(22) Filed: Oct. 25, 2001

(51) Int. Cl. B25B 23/16

(52) U.S. Cl. 81/177.75

(57) ABSTRACT

A torque multiplier having an output socket which allows to pivotally join an output action bar having a ball head for applying a resultant torque in multiple positions, said torque multiplier comprising: a housing having a first and a second end, two torque multiplier reaction arms, a multiplier gear mechanism having a torque input and a torque output located inside said housing and a torque output socket linked to the mechanism torque output, wherein said torque output socket including means for pivotally joining a torque output member allowing the movement of said output member 360° around the output socket.

### BACKGROUND OF INVENTION

The present invention is related to torque multipliers, and more particularly to a torque multiplier having means for pivotally attaching an input/output socket which allows to apply the resultant torque at different angles and positions without the necessity of moving the torque multiplier.

There are well known the mechanical and pneumatic torque multipliers for screwing and unscrewing nuts or the like.

A common mechanical torque multiplier comprises a housing having a first and a second end with a through opening in which it is mounted a torque multiplier mechanism. Said first end including a female input socket for attaching a torque wrench and a male/female output socket for a attaching the head of a torque output member which may be an output wrench, and said housing having a multiplier reaction arm providing a resting point for preventing the rotation of the apparatus when applying a torque.

Examples of torque multipliers having the above referred characteristics are described in the following U.S. Pat. No. 3,979,965 of Vuseta, U.S. Pat. No. 3,992,964 of Osmond, U.S. Pat. No. 4,212,196 of Krieger, U.S. Pat. No. 4,213,333 of Krieger, U.S. Pat. No. 4,215,599 of Batchhelder, U.S. Pat. No. 4,274,310 of Michaud, U.S. Pat. No. 4,596,165 of White, U.S. Pat. No. 4,666,756 of Snider and U.S. Pat. No. 5,123,308 of Shaffer.

The main disadvantage of the prior art torque multipliers is that there are unable to apply its resultant torque to multiple positions i.e. reach several nuts from the same position, thus, it is necessary to line up the apparatus and output wrench with each nut for each operation, which is not convenient considering the weight of some of those apparatuses.

Therefore, it would be highly desirable to have a torque multiplier by which multiple reaction points may be reached from only one rest point without the necessity of moving the apparatus.

In view of the above referred necessity, the applicant developed a torque multiplier having an output socket which allows to pivotally join an output action bar having a ball head for applying a resultant torque in multiple points.

Applicant's torque multiplier, comprises: a housing having a first and a second end, two torque multiplier reaction arms, a multiplier gear mechanism having a torque input and a torque output located inside said housing and a torque output socket linked to the mechanism torque output, wherein said torque output socket including means for pivotally joining a torque output member allowing the movement of said output member 360° around the output socket.

Thanks to the use of two reaction arms, there are provided two support points by which it is achieved an improved functionality for reaching difficult to reach points.

Furthermore, the output socket of the present invention may be adapted to any kind of torque multiplier such as pneumatic or mechanical torque multipliers.

### SUMMARY OF INVENTION

It is therefore a main objective of the present invention to provide a torque multiplier having an output socket which allows to pivotally join an output action bar having a ball head for applying a resultant torque in multiple positions.

It is also a main objective of the present invention to provide a torque multiplier having the above referred characteristics by which multiple action points may be reached from only one position without the necessity of moving the apparatus.

It is another objective of the present invention to provide a torque multiplier having the above referred characteristics in which thanks to the use of two reaction arms, there are provided two support points by which it is achieved an improved functionality for reaching points which are very difficult to reach.

It is still another objective of the present invention to provide a torque multiplier having the above referred characteristics which may be adapted to any kind of torque multiplier such as pneumatic or mechanical torque multipliers.

These and other objects and advantages of the torque multiplier of the present invention will become apparent to those persons having an ordinary skill in the art, from the following detailed description of the embodiments of the invention, which will be made with reference to the accompanying drawings.

### BRIEF DESCRIPTION OF DRAWINGS

The features of the invention believed to be novel are set forth in the appended claims. The invention, however, together with further objects and advantages thereof, may best be understood by reference to the following description taken in conjunction with the accompanying drawing(s) in which:

FIG. 1 is a lateral view of a conventional torque multiplier.

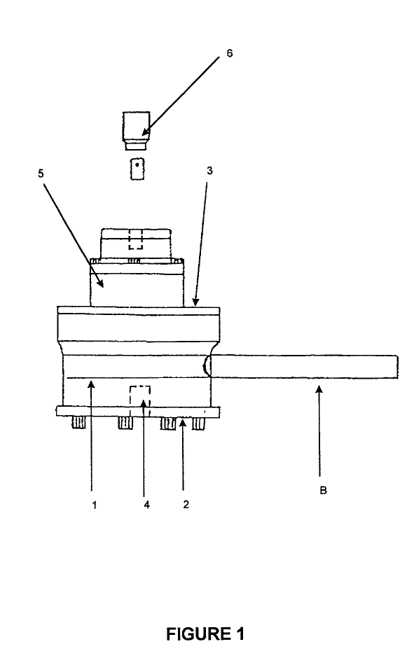

FIG. 2 is a front view of a conventional torque multiplier.

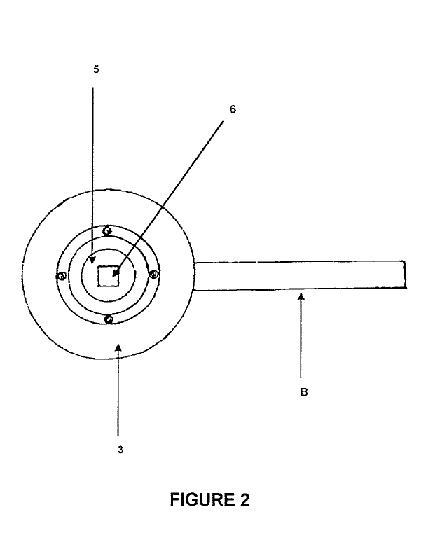

FIG. 3 is a view in perspective of the output socket of the present invention.

FIG. 4 is a view in perspective of a preferred embodiment of the torque multiplier of the present invention.

FIG. 5 is a lateral view of a preferred embodiment of the torque multiplier of the present invention.

FIG. 6 is a front view of a preferred embodiment of the torque multiplier of the present invention.

### DETAILED DESCRIPTION

The torque multiplier of the present invention will be described making reference to a preferred embodiment thereof and will be firstly described making reference to a common mechanical torque multiplier illustrated in the accompanying drawings wherein the same signs and numbers, refer to the same parts of the shown figures, said common torque multiplier comprising:a housing 7 having a through opening (not shown) and a first 2 and a second end 3; a reaction bar “B” linked to the housing; a torque multiplier mechanism (not shown) located inside the housing 1 and having torque input means (not shown) and a torque output means (not shown), located at a first 2 and second end 3 of the housing 7; a female torque input socket 4 connected to the torque input means and located at the first end 2 of the housing for receiving a torque wrench; a female output socket 5 connected to the torque output means and located at the second end 3 of the housing 7 for receiving a torque output member 6.

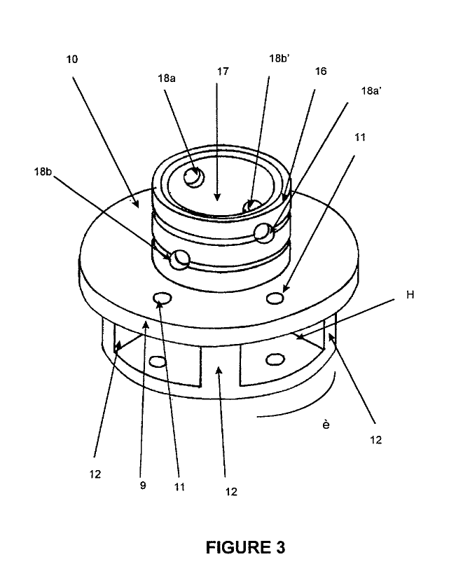

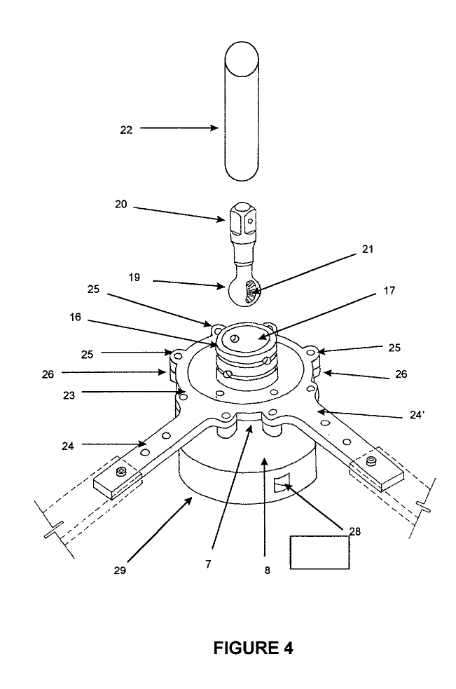

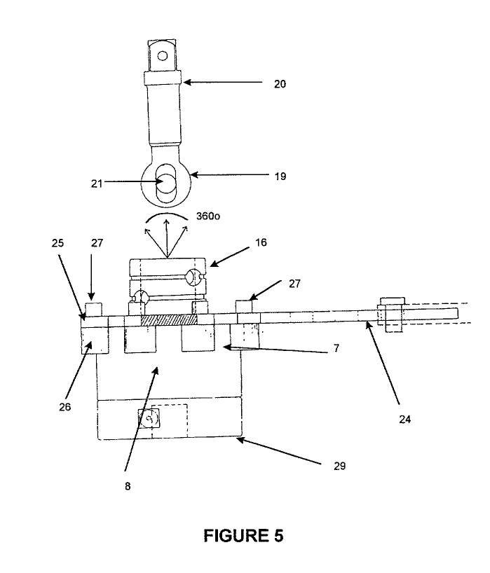

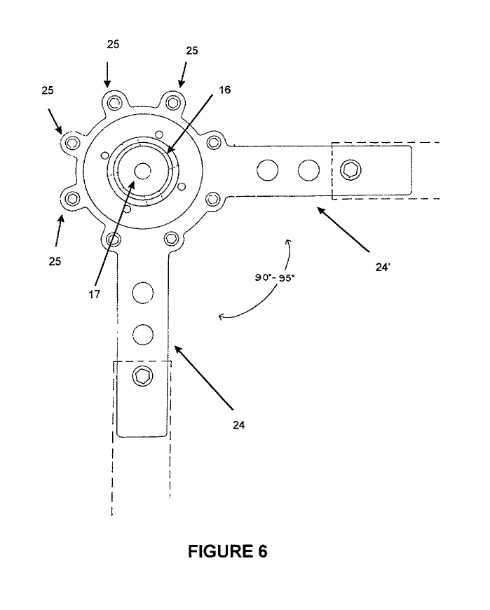

The output socket of the present invention (shown in FIG. 3) which allows to pivotally join reacting means is connected to the output means of the torque multiplier mechanism of a modified torque multiplier apparatus (shown in FIGS. 4, 5 and 6) and is located at the second end 7 of said modified torque multiplier housing case 8, wherein the output socket of the present invention comprising: a circular metallic base 9 having the same diameter of the torque multiplier housing case and a first 10 and a second surface (not shown) linked to the output means (not shown) and including a plurality of perforations 11 for linking the metallic base 9 to the torque multiplier mechanism output means; four skirts 12 (only three skirts shown), each having a first end 13 and a second end 14, joined to the second surface, and each skirt 12 located equidistantly from each other at an angle θ; a circular disc 15 having a central perforation (not shown) joined to the first end 13 of each skirt 12, forming an open housing “H” with the second surface of the circular metallic base 9, said open housing located inside the second end 7 of the torque multiplier housing 8 case and receiving part of the torque multiply gearing; a circular socket located at a central portion of the first surface 10, having a cylindrical wall 16 and an internal housing 17, said cylindrical wall 16 having two pairs of coincident bores 18a, 18a′, 18b, 18b′ allowing the pass of a bolt (not shown); and a spring (not shown) located inside the internal housing 17; The internal housing 17 of the circular socket receives the ball head 19 of an output action device 20, which is retained inside the internal housing 17 by means of a bolt (not shown) passing through a perforation in the ball head 21 and trough the coincident perforations 18, 18′ of the circular socket, additionally preventing the rotational movement of the ball head 19 over its own axis. The ball head compress the spring, which applies an opposed force, thus preventing that the ball head remain idle inside the internal housing 17.

By this means, an action bar 22 joined to the ball head may oscillate 360° around the center of the output socket, allowing the bar 22 to reach and apply the output torque in multiple points without moving the apparatus.

In this preferred embodiment, it is included a ring 23 having two telescopic multiplier reaction arms 24, 24′, which are separated at an angle of 90°-95° from each other. Said ring 23 includes a plurality of small semi-rings 25 depending from the periphery of the main ring 23, allowing the pass of a bolt, and said semi-rings 23 coinciding with metallic counterpart cylindrical housing members 26 linked at the periphery of the second end 7 of the torque multiplier housing case 8, each including a perforation (not shown) having an internal thread receiving a bolt 27. In this way, the main ring 23 with its telescopic multiplier reaction arms 24, 24′, is linked to the torque multiplier housing case 8.

Also, it is included an additional housing 28 near the first end 29 of the torque multiplier for receiving an additional reaction arm (not shown).

Although it was described in the present embodiment that the torque multiplier of the present invention includes two reaction arms 24, 24′, it is possible that in other embodiments of the invention, the torque multiplier may not include any reaction arm, which may be included in a torque output member, for example a wrench connected to the output socket.

Also, it is possible that the output socket of the present invention may be comprised only by the circular socket, which may be adapted to the output socket of any kind of torque multiplier and joined thereof by welding.

Finally it must be understood that the torque multiplier of the present invention, is not limited exclusively to the above described and illustrated embodiments and that the persons having ordinary skill in the art can, with the teaching provided by this invention, be enabled to make modifications to the design and component distribution of the torque multiplier of the present invention, which will clearly will be within the true inventive concept and scope of the invention which is claimed in the following claims.

While only certain preferred features of the invention have been illustrated and described, many modifications and changes will occur to those skilled in the art. It is, therefore, to be understood that the appended claims are intended to cover all such modifications and changes as fall within the true spirit of the invention.

1. A torque multiplier comprising a housing having a first and a second end, a multiplier mechanism having a torque output located inside said housing and a torque output socket linked to the mechanism torque output, wherein said torque output socket including means for pivotally joining a torque output member and allowing its movement around 360° around the output socket.

2. A mechanical torque multiplier comprising a housing having a first and a second end, a multiplier gear mechanism having a torque input and a torque output located inside said housing and a torque output socket linked to the mechanism torque output, wherein said torque output socket including means for pivotally joining a torque output member and allowing its movement around 360° around the output socket.

3. A torque multiplier according to claim 2, wherein the output socket comprising:
a circular metallic base having a first surface and a second surface linked to the mechanism output torque and having the same diameter of the torque multiplier housing case;
three skirts each having a first end and a second end downwardly depending from the periphery of the circular metallic base and oriented internally to the second surface, and each skirt located equidistantly from each other at a constant angle;
a circular ring joined to the first end of each skirt, forming an open housing with the second surface of the circular metallic base, said open housing being inside the second end of the torque multiplier housing case and receiving a part of the torque multiply gear mechanism;
a circular socket located at a central portion of the first surface, having a cylindrical wall and an internal housing, said cylindrical wall having two coincident bores, allowing the pass of a bolt; and
a spring located inside the internal housing;
Wherein the internal housing of the circular socket receives the ball head of an output member, which is retained inside the internal housing by means of a bolt passing through a perforation in the ball head and trough the coincident perforations of the circular socket, additionally preventing the rotational movement of the ball head over its own axis, and wherein the ball head compress the spring which applies an opposed force which prevents the ball head to remain idle inside the internal housing.

4. A torque multiplier according to claim 1, further including a ring having two telescopic multiplier reaction arms, which are separated at an angle of 90°-95° from each other, and said ring linked to the torque multiplier housing case by means of a plurality of small semi-rings depending from the periphery of the main ring, allowing the pass of a bolt, and said semi-rings coinciding with metallic counterpart members linked at the periphery of the torque multiplier housing case, each including a perforation having an internal thread receiving a bolt.

5. A torque multiplier according to claim 2, further including a ring having two telescopic multiplier reaction arms, which are separated at an angle of 90°-95° from each other, and said ring linked to the torque multiplier housing case by means of a plurality of small semi-rings depending from the periphery of the main ring, allowing the pass of a bolt, and said semi-rings coinciding with metallic counterpart members linked at the periphery of the torque multiplier housing case, each including a perforation having an internal thread receiving a bolt.

6. A torque multiplier according to claim 1, further including a ring having two telescopic multiplier reaction arms, which are separated at an angle of 90°-95° from each other, and said ring linked to the torque multiplier housing case by means of a plurality of small semi-rings depending from the periphery of the main ring, allowing the pass of a bolt, and said semi-rings coinciding with metallic counterpart members linked at the periphery of the second end of the torque multiplier housing case, each including a perforation having an internal thread receiving a bolt.

7. A torque multiplier according to claim 2, further including a ring having two telescopic multiplier reaction arms, which are separated at an angle of 90°-95° from each other, and said ring linked to the torque multiplier housing case by means of a plurality of small semi-rings depending from the periphery of the main ring, allowing the pass of a bolt, and said semi-rings coinciding with metallic counterpart members linked at the periphery of the second end of the torque multiplier housing case, each including a perforation having an internal thread receiving a bolt.

8. A torque multiplier according to claim 1, wherein the torque multiplier housing case including a perforation for receiving an additional reaction arm.

9. A torque multiplier according to claim 2, wherein the torque multiplier housing case including a perforation for receiving an additional reaction arm.

10. A torque multiplier according to claim 1 wherein the output socket comprises a cylindrical socket which may be adapted to the output socket of any kind of torque multiplier and joined thereof.

11. A torque multiplier according to claim 2 wherein the output socket comprises a cylindrical socket which may be adapted to the output socket of any kind of torque multiplier and joined thereof.

12. A torque multiplier according to claim 1 wherein the output socket comprises a cylindrical socket which may be adapted to the output socket of any kind of torque multiplier and joined thereof by welding.

13. A torque multiplier according to claim 2 wherein the output socket comprises a cylindrical socket which may be adapted to the output socket of any kind of torque multiplier and joined thereof by welding.
